(19) United States
(12) Patent Application Publication
(10) Pub. No.: US 2025/0007294 A1
(43) Pub. Date: Jan. 2, 2025

(54) INVERTER POWER SYNCHRONIZATION

(71) Applicant: Alliance for Sustainable Energy, LLC, Golden, CO (US)

(72) Inventors: Gabsu SEO, Highlands Ranch, CO (US); Nathan BAECKELAND, Lakewood, CO (US)

(21) Appl. No.: 18/680,696

(22) Filed: May 31, 2024

Related U.S. Application Data
(60) Provisional application No. 63/505,083, filed on May 31, 2023.

(51) Int. Cl. H02J 3/40; H02J 3/00; H02J 3/18; H02M 1/00; H02M 7/53

(52) U.S. Cl. CPC H02J 3/40; H02J 3/001; H02J 3/1835; H02M 1/0016; H02M 7/53

(57) ABSTRACT

A device includes at least one processor configured to determine a reference quantity based on a difference between a reference output power for a power inverter and an actual output power of the power inverter and cause the power inverter to control its power output based on the reference quantity. The at least one processor may be further configured to, responsive to the power inverter entering current-limiting operation, determine a non-zero power term that represents an additional amount of power that the inverter would have outputted if not current-limited; and determine the reference quantity based further on the non-zero power term.

### CROSS REFERENCE TO RELATED APPLICATIONS

This application claims the benefit of U.S. Provisional Application No. 63/505,083, titled “Frequency and Voltage Stabilization Method for Grid-Connected Inverters in Abnormal Conditions” and filed May 31, 2023, the entire content of which is incorporated herein by reference.

### CONTRACTUAL ORIGIN

This invention was made with United States government support under Contract No. DE-AC36-08GO28308 awarded by the U.S. Department of Energy. The United States government has certain rights in this invention.

### BACKGROUND

Renewable energy sources and technologies such as solar photovoltaics, wind turbines, battery storages, fuel cells, and high-voltage direct current (HVDC) lines employ power electronics inverters to connect and deliver energy to the electrical grid or other power system. The majority of inverters in today's grid are of the grid-following type. These inverters track the grid using a phase-locked loop (PLL) and latch onto it to provide power. However, in recent years, a paradigm shift towards grid-forming inverters has been initiated. These inverters do not track an existing grid but rather create their own voltage and frequency reference and, as such, may create the potential to operate the future grid with up to 100% renewables.

### SUMMARY

In accordance with various aspects of the disclosure, a device includes at least one processor configured to determine a reference quantity based on a difference between a reference output power for a power inverter and an actual output power of the power inverter and cause the power inverter to control its power output based on the reference quantity. The at least one processor may be further configured to, responsive to the power inverter entering current-limiting operation: determine a non-zero power term that represents an additional amount of power that the inverter would have outputted if not current-limited and determine the reference quantity based further on the non-zero power term.

In another example, a method includes providing, by a power inverter that includes at least one processor, power to a power system to which the power inverter is connected, assigning, by the power inverter, a zero value to a power term, and responsive to detecting an abnormal operating condition, calculating, by the inverter, a non-zero value for the power term. The power term may be used by the power inverter to synchronize, to the power system, the power output by the power inverter.

The details of one or more examples are set forth in the accompanying drawings and the description below. Other features, objects, and advantages will be apparent from the description and drawings, and from the claims.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a power system in which assorted embodiments of a power synchronization system may be practiced.

FIG. 2 illustrates a block representation of portions of an electrical power system configured and operated in accordance with various embodiments.

FIG. 3 illustrates a block representation of aspects of a power synchronization system that may operate in accordance with assorted embodiments.

FIG. 4 illustrates a generic grid-forming control structure implementing the imaginary power compensation control method, according to some aspects of the present disclosure.

FIG. 5 illustrates a single-machine to infinite bus simulation setup for the imaginary power compensation control method, according to some aspects of the present disclosure.

FIG. 6 illustrates computation of the imaginary power compensation control method into dq-frame control blocks, according to some aspects of the present disclosure.

FIG. 7 illustrates operational results for example power synchronization systems configured and operated in accordance with various embodiments.

FIG. 8 illustrates a flowchart of a power synchronization routine that may be carried out with the various embodiments of a power synchronization system.

FIG. 9 illustrates a flowchart of imaginary power compensation control that may be carried out with the various embodiments of a power synchronization system.

### DESCRIPTION

Various embodiments are directed to systems that provide power synchronization and delivery, particularly in abnormal conditions. The use of an intelligent controller in an inverter of a power system may generate and utilize reference terms to provide electrical power through a diverse variety of operating conditions.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to +20%, ±15%, ±10%, ±5%, or +1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

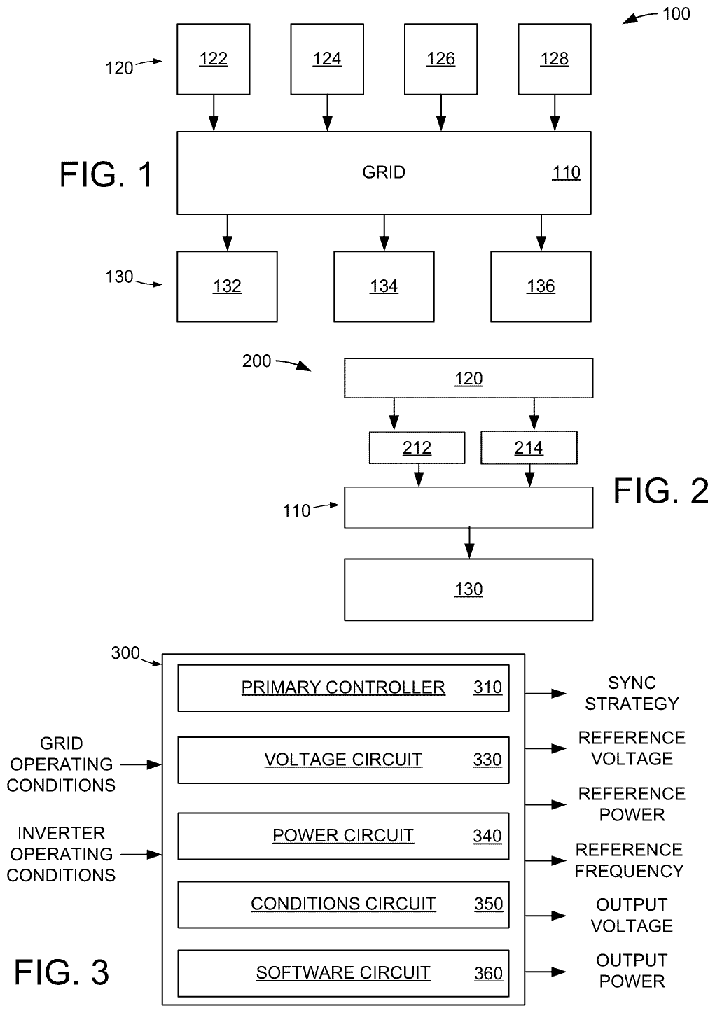

FIG. 1 illustrates a power system 100 in which assorted embodiments of a power synchronization system may be practiced. The power system 100 has a network of connections, which is collectively characterized as a grid 110, that provide electrical power from one or more power sources 120 to one or more loads 130. The construction, capabilities, performance, and location of the grid 110 is not limited and may be arranged in accordance with a variety of embodiments to provide stable electrical power over time.

As a non-limiting example, the power system 100 may employ one or more renewable energy sources, such as wind turbines 122, solar panels 124, and hydroelectric generators 126, along with conventional power sources, such as coal power plants 128, to supply electrical power to the grid 110, which distributes the electrical power to one or more power consumers, such as a residential site 132, commercial site 134, and industrial site 136.

The ability to utilize a variety of different power sources 120 to supply a variety of separate loads 130 allows for robust electricity delivery in many conditions. FIG. 2 illustrates a block representation of portions of an electrical power system 200 configured and operated in accordance with various embodiments to supply electric power generated by one or more power sources 120 to one or more loads 130. While some power sources 120 may generate electricity with alternating current (AC), some power sources 120, particularly renewable power sources 122/124/126, may generate electricity with direct current (DC).

To accommodate the transmission and distribution of electrical power with the grid 110, one or more inverters may be utilized to convert DC power to AC power. One or more of power sources 120 may employ grid-following inverters 212 and/or grid-forming inverters 214 to convert electrical power before, during, or after transmission through grid 110 to assorted loads 130.

Grid-forming inverters 214 typically employ a primary controller 220 to generate an internal reference voltage and phase angle for power output. It is contemplated that the controller 220 may employ one or more operations, such as droop algorithms, virtual-synchronous machines, or virtual oscillators, to synchronize with the power system 200 and participate in power provision without the need for additional communication or grid-voltage tracking. Such synchronization may be similar to how synchronous machines operate to provide reliable electric power delivery under normal operating conditions.

However, when there is a contingency in the power system 200, such as grid faults, overloading, or phase jumps, an inverter 212/214 may be forced into a current limiting mode to avoid damaging the inverter's power electronics components, such as semiconductor switches. With the output limited due to hardware limitations, grid-forming inverters 214 may be prone to losing synchronism with the power system 200 as they may be unable to reach a stable operating point matched with one that the primary control drives.

Some related-art embodiments of a primary controller are directed to mitigating the loss of synchronism of grid-forming inverters during current limiting conditions. However, such techniques are mostly limited to addressing either frequency jumps or voltage drops. Other proposed solutions may work for both concerns, but it is unclear what the intuitive meaning behind the tuning gain represents, and how to tune it to guarantee electrical stability with reasonable trade-offs. In addition, these proposed related-art solutions only consider one inverter connected to an infinite bus, but their effectiveness is in question in inverter dominated networks, such as induced dynamic transients, and in real events, such as line faults or blackstarts. Thus, there remains a need for systems, processes, and routines to stabilize grid-connected power electronics during abnormal operating conditions.

Accordingly, embodiments of the present disclosure are directed to optimized power synchronization during abnormal operating conditions. FIG. 3 illustrates aspects of a power synchronization system that may operate in accordance with assorted embodiments. The block representation in FIG. 3 conveys an example power inverter 300 that receives, as input DC power, generates a variety of reference values, and utilizes such values to generate and output AC power that conforms to a synchronization strategy.

In some embodiments, a primary controller 310 processes the various input information about grid conditions as experienced at inverter 300 along with the operating conditions of the inverter 300, such as output current, to calculate a reference voltage and/or a reference power value for use by other components of inverter 300. While the primary controller 310 may conduct various processing and value calculations alone, the inverter 300 may employ specific circuitry to conduct one or more aspects of the constituent aspects of a synchronization strategy.

For instance and in no way limiting of potential hardware that may be employed in an inverter 300, a voltage circuit 330 may utilize one or more algorithms and terms to calculate a reference value for an output voltage that promotes synchronization of delivered power with the grid, including during abnormal conditions. As a specific example, the voltage circuit 330 may determine a reference voltage as a zero value, which may be characterized as ignoring an algorithm term, until prompted by the primary controller 310 to calculate a new reference voltage value in response to an abnormal grid condition.

Similarly to the voltage circuit 330, a power circuit 340 may provide an output AC power conducive to detected, and predicted future, grid conditions by ignoring, or calculating one or more algorithm terms. It is noted that one or more of the voltage and power terms managed and calculated by the inverter in response to abnormal grid conditions may be characterized herein as “imaginary” or “fictitious”, which corresponds to the inverter 300 generating such term temporarily to accommodate abnormal grid conditions until the grid returns to nominal performance. In other words, an “imaginary” or “fictitious” power or voltage term may represent a hypothetical power or voltage term, as opposed to an actual power or voltage term.

The primary controller 310, in some embodiments, processes input information to determine if an abnormal grid condition exists. However, the primary controller 310 may be supplemented by a conditions circuit 350 that evaluates current grid conditions and, in various embodiments, predicts future grid conditions. Such an ability to continuously, routinely, or sporadically evaluate grid conditions allows the inverter 300 to efficiently calculate compensatory output voltage and/or power to maintain, or return to, nominal grid performance through an abnormal grid operating condition. It is contemplated that the conditions circuit 350 may predict abnormal grid conditions in time for the inverter 300 to adjust output voltage and/or power to prevent the occurrence, or reduce severity, of the abnormal condition.

In accordance with various embodiments, the assorted aspects of the inverter 300 may be present in hardware or software. Hence, a controller or circuit may be a semiconductor, application specific integrated circuit (ASIC), system on chip (SOC), and/or executable code stored on temporary or permanent memory of the inverter 300. A software circuit 360, in some embodiments, may conduct one or more operational aspects of the inverter 300 as a virtual system, such as a virtual synchronous machine (VSM) or virtual oscillator control (VOC). The use of such virtual aspects may provide more efficient and/or reliable reactions to abnormal grid conditions to provide output voltage and output power that synchronizes with the grid and aids in overcoming the abnormal conditions.

In sum, embodiments of the present disclosure generally relate to a power synchronization system that executes an imaginary power compensation control method in response to detected, or predicted, grid conditions. As a result, an inverter 300 may stabilize grid-connected power electronics converters under abnormal operating conditions, such as voltage jumps, frequency jumps, phase jumps, overloading, or a combination thereof. An imaginary power compensation control method may describe a synchronization method for grid-forming inverters to make them robust and frequency-stable during abnormal grid conditions so that they do not lose synchronism with the grid.

To accomplish this, embodiments of a synchronization strategy may employ an imaginary power compensation control method to introduce virtual power and control how it manipulates the reference signals provided by the primary controller 310 of a grid-forming inverter 300. The imaginary power compensation control method may mimic the dynamic behavior of a synchronous generator, which enables it to predict and intuitively understand the behavior of the inverter 300 under non-ideal conditions. Further, the imaginary power compensation control method may be tuned based on classical synchronous generator theory.

As an example of the imaginary power compensation control method that may be part of a synchronization strategy, begin by considering the following power-frequency and voltage-reactive power droop equations:

$$\frac{d θ}{dt} = {ω}_{0} + {m}_{p} ( {P}^{*} - P ) \qquad ( 1 )$$

$${E}^{*} = {E}_{0} + {m}_{q} ( {Q}^{*} - Q ) \qquad ( 2 )$$

where θ represents the instantaneous internal grid-forming (GFM) reference angle, ω₀ denotes the nominal grid angular frequency, mₚ denotes the ω-P droop gain, and P* and P represent the active power reference and the GFM active power output, respectively, E* denotes the reference voltage fed to the voltage controller, E₀ denotes the nominal output voltage, m_{q} represents the V-Q droop gain, Q* and Q denotes the reference and actual output reactive power, respectively. During the current-limited operation of a GFM inverter, it is likely that the output power of the GFM inverter may not satisfy the reference power setpoint in equation (1). As such, the term mₚ (P*−P) in equation (1) is non-zero (in case the grid frequency is nominal) and the internal GFM inverter reference frequency starts to diverge from the grid frequency. If this situation prolongs, this can lead to total loss of synchronism and grid instability at large. To avoid such severe loss of synchronism, the imaginary power compensation control method adds an additional term to equation (1) as expressed below:

$$\frac{d θ}{dt} = {ω}_{0} + {m}_{p} ( {P}^{*} - P - {P}_{fict} ) \qquad ( 3 )$$

where the imaginary power compensation control method introduces a fictitious power term P_{fict}. When the inverter 300 is current limited, a certain amount of power is prevented from being injected into the grid. This fictitious power term accounts for the power that is not being injected due to current limiting. In that spirit, the voltage reference equation (2) can be modified to add a fictitious reactive power term as well:

$${E}^{*} = {E}_{0} + {m}_{q} ( {Q}^{*} - Q - {Q}_{fict} ) \qquad ( 4 )$$

Although the addition of Q_{fict} will indirectly affect the inverter's angle dynamics captured by equation (3), that effect is rather small compared to P_{fict}. Therefore, this analysis focuses primarily on P_{fict}. To reduce implementation complexity, in some embodiments, the Q_{fict} term could be dropped. In the complex phasor domain, the fictitious power may be calculated as follows:

$${S}_{fict} = {\underline{E}}^{*} \overline{( \frac{{\underline{E}}^{⋆} - \underline{E}}{{\underline{Z}}_{X}} )} , with {P}_{fict} = ℜ ( {S}_{fict} ) \qquad ( 5 )$$

where E denotes the complex output voltage of the inverter (depending on the type of output filter and the measurement point used in the inverter's hardware, this voltage can be slightly different), E* denotes the complex reference voltage governing by the primary controller, and Z_{X} denotes an impedance, which is a design parameter. In the true meaning of “the power not being injected due to the current limiter,” the design impedance Z_{X} in equation (5) should be Z_{g}, the grid-side filter impedance (e.g., the outer inductor L of the LCL filter). However, by making Z_{X} a design parameter, control over the angle and amplitude of P_{fict} that modulate the dynamics of the stabilization method is gained. In some embodiments, Z_{X} may be tuned as if it were the internal impedance of a synchronous generator. Similarly, in some embodiments, Z_{X} is chosen as a small value, such as approximately 0.02-0.2 p.u., and almost purely inductive. It is noted that the fictitious term can be tuned to an angle of Z_{X} values greater than approximately 90°, at times. As such, in terms of voltage-angle dynamics, a GFM inverter during current-limited operation may behave similar to a synchronous generator with an internal impedance of Z_{X}. In some embodiments, the amplitude of Z_{X} may be tuned to allow a certain amount of dynamic “swing” of the inverter's internal angle during current limiting.

In equation (5), the fictitious power is given in the complex phasor domain, where Z_{X} is a complex design parameter and, as such, both the magnitude and the angle may be tuned. As previously mentioned, Z_{X} can be tuned to mimic a synchronous machine, such as a small impedance value and purely inductive angle. In practice, a user, such as an inverter manufacturer, could set Z_{X} at a default to a typical internal impedance value seen in synchronous generators with a comparable power rating to the inverter. Depending on the grid in which the inverter is implemented, a tuning of Z_{X} may be more beneficial in certain situations. For stability reasons, in some embodiments, a relatively higher Z_{X} may be chosen in weak (micro-) grids with more angle swing during current limiting conditions, whereas a small Z_{X} is a better choice in stiff grids with less angle swing. Making Z_{X} adaptable over time is an option: the value of Z_{X} could be manipulated in live operation—either by some controls inside of the inverter or by an external communication signal or device, which may depend on the varying stiffness of the grid or seasonal changes of the generation mix with varying renewable energies. Apart from the magnitude of Z_{X}, the angle may also be tuned.

In some embodiments, the imaginary power compensation control method may deviate from the conventional assumption of E_{q}*=0. In some embodiments, the imaginary power compensation control method includes a fictitious power term that is a function of E*. In some embodiments, the term Rₓ may be set to negative values to compensate for losses in the output LCL filter. With this flexibility to tune Rₓ, the imaginary power compensation control method may compensate for the negative effects of the current limiter by manipulating the power-angle curve. In some embodiments, the imaginary power compensation control method also computes a fictitious reactive power term, Q_{fict} (see equation (4)), which can be fed back to the primary controller 310. The imaginary power compensation control method may implement this Q_{fict} term into the primary controller 310.

The primary controller 310 of a grid-forming inverter 300 may be responsible for regulating the output voltage and frequency of the inverter 300, based on power setpoints and measurements. The imaginary power compensation control method is not bound to any particular type of primary controller 310. For example, in some embodiments, primary controllers using methods other than droop control, such as VSM-based and VOC-based primary controllers, may be used in conjunction with the imaginary power compensation control method. For example, for a VSM-based primary controller the imaginary power compensation control method can be expressed as:

$$\frac{{d}^{2} θ}{{dt}^{2}} = \frac{1}{M} ( {P}^{*} - P - {P}_{fict} + \frac{1}{{m}_{p}} ( {ω}_{0} - ω ) ) , \qquad ( 6 )$$

$${E}^{*} = {E}_{0} + {m}_{q} ( {Q}^{*} - Q - {Q}_{fict} ) .$$

For dVOC, the imaginary power compensation control method can be expressed by:

$$\frac{d θ}{dt} = {ω}_{0} + \frac{{κ}_{v} {κ}_{i}}{3 {C ( {E}^{*} )}^{2}} ( {P}^{*} - P - {P}_{fict} ) , \qquad ( 7 )$$

$$\frac{d {E}^{*}}{dt} = \frac{ξ}{{κ}_{v}^{2}} {E}^{*} ( 2 {E}_{0}^{2} - 2 {( {E}^{*} )}^{2} ) + \frac{{κ}_{v} {κ}_{i}}{3 {CE}^{*}} ( {Q}^{*} - Q - {Q}_{fict} )$$

In some embodiments, such as those shown in equations (6) and (7), the fictitious power shows up in a similar fashion as in droop control. As long as a primary controller penalizes a difference in power reference and power output to govern an angle and voltage reference, the imaginary power compensation control method may be utilized.

The imaginary power compensation control method is not bound by any reference frame and can be extended to other reference frames, including the stationary (αβ) reference frame, natural (abc) reference frame, and others. For example, calculating equation (5) in the dq reference frame yields the following:

$${P}_{fict} = \frac{1}{{R}_{x}^{2} + {X}_{x}^{2}} ( {E}_{d}^{*} Δ {E}_{d} {R}_{x} + {E}_{d}^{*} Δ {E}_{q} {X}_{x} + {E}_{q}^{*} Δ {E}_{q} {R}_{x} - {E}_{q}^{*} Δ {E}_{d} {X}_{x} ) \qquad ( 8 )$$

$${Q}_{fict} = \frac{1}{{R}_{x}^{2} + {X}_{x}^{2}} ( {E}_{q}^{*} Δ {E}_{d} {R}_{x} + {E}_{q}^{*} Δ {E}_{q} {X}_{x} + {E}_{d}^{*} Δ {E}_{q} {R}_{x} - {E}_{d}^{*} Δ {E}_{d} {X}_{x} )$$

where Rₓ and Xₓ denote the restrictive and reactive parts of the impedance, Z_{y}, respectively, ΔE_{d}=E_{d}*−E_{d}, and ΔE_{q}=E_{q}*−E_{q}.

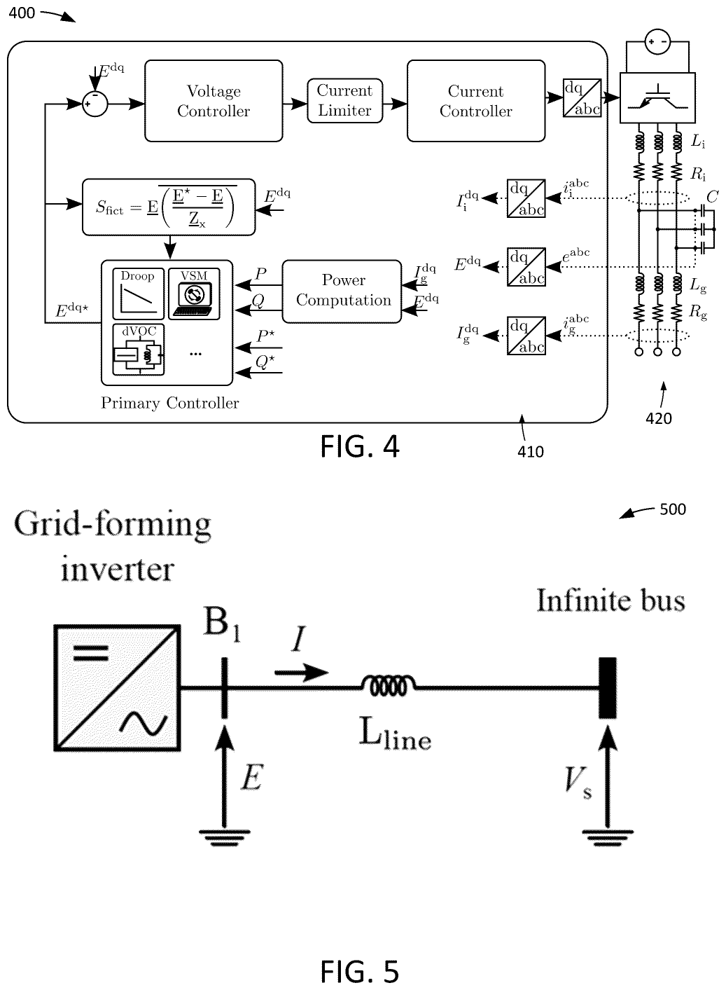

FIG. 4 illustrates aspects of a power system 400 arranged in accordance with various embodiments to provide intelligent reactions to abnormal grid conditions. It is noted that the power system 400 may employ any number of inverters 410 to provide synchronized power and voltage to an electrical grid 420. The assorted aspects of the inverter 410 shown in FIG. 4 may, in some embodiments, supplement, or replace, aspects shown in FIG. 3.

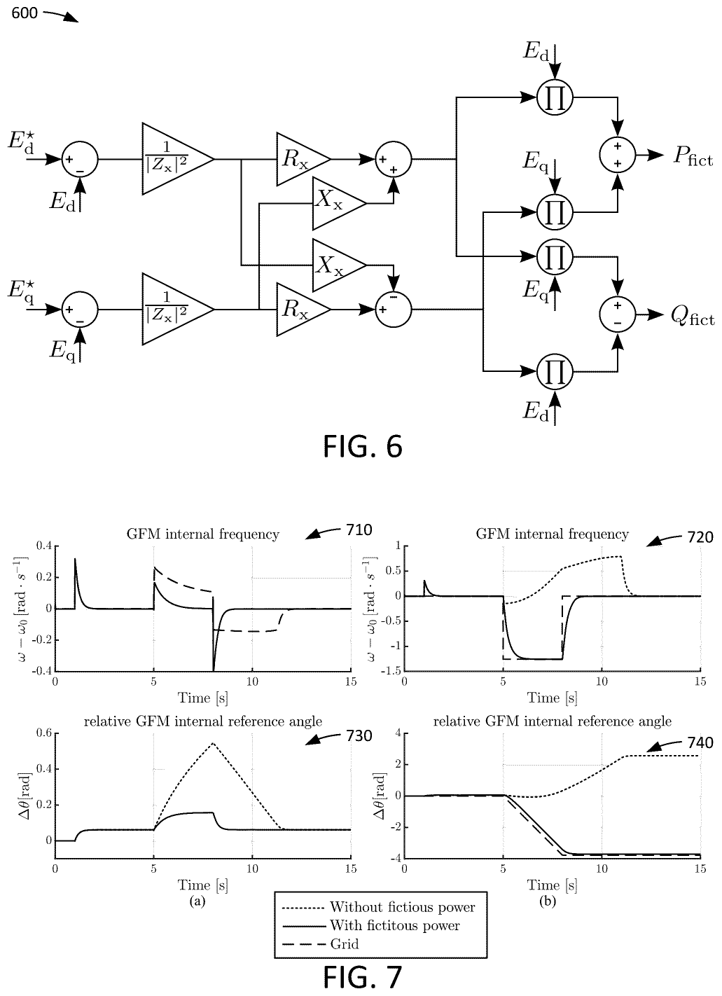

FIG. 6 represents the translation of equation (8) into dq-frame control blocks in accordance with various embodiments. To illustrate the effect of adding the fictitious power to the primary controller 310, simulation results are presented in FIG. 7, which conveys the single-machine-to-infinite-bus simulation setup shown in FIG. 5, where one GFM inverter is connected to a bus with an ideal voltage source through an inductive line. In this simulation, two non-ideal scenarios may be contemplated: i) a voltage drop at the infinite bus of approximately 0.5 p.u., and ii) a grid frequency drop of approximately 0.2 Hz. Both faults are activated between t=5 s and t=8 s.

FIG. 7 shows the results of the simulation of the system shown in FIG. 5 while leveraging the fictitious power term (solid lines) and without (segmented lines). In both cases, such as the voltage drop shown by curves 710 and 730 as well as the frequency drop shown in curves 720 and 740, a tremendous improvement in transient stability is observed. First, curves 710 and 730 show the frequency and angle stability of the grid-forming inverters against a voltage drop. As shown, the conventional grid-forming control, without the fictitious term added, cannot stabilize during the fault due to the frequency inequality between the inverter and the grid. Since the inverter angle continuously deviates from the grid as shown, it may not come back to a normal operation with stability if it exceeds a critical point, such as a critical clearing angle, after the fault if it prolongs. On the other hand, when using the imaginary power compensation control method disclosed herein, the inverter can stabilize the frequency and angle during the fault, which allows not only stable operation during fault, but also quick recovery to normal operation after the fault. The curves 720 and 740 compare the dynamic behaviors under a frequency jump, which illustrate the resulting stability improvement.

In some embodiments, the imaginary power compensation control method may be implemented using droop control, Virtual Synchronous Machines (VSM) control, or Virtual Oscillator-based Control (VOC). Any primary controller that uses a difference between a reference power, P*, and the actual output power, P, to govern an internal angle reference can leverage the imaginary power compensation control method. As long as there is information about the measured output voltage and the generated internal reference voltage, the fictitious power can be calculated according to equation (5), for the robust synchronization. In addition, in some embodiments, Q_{fict} can also be used for additional functionality.

In some embodiments, the imaginary power compensation control method may be performed in the synchronous reference frame (SRF, also called dq-frame or rotating reference frame). In some embodiments, the imaginary power compensation control method is performed in the decoupled double synchronous reference frame, the stationary reference frame, or the natural reference frame. That is, the reference frame does not have a significant impact on implementation of the imaginary power compensation control method.

In some embodiments, the imaginary power compensation control method may be performed under balanced or unbalanced conditions. For unbalanced condition handling, the decoupled double SRF or stationary reference frame may be leveraged. With equation (5), the fictitious power term may be calculated, which will have a ripple signal superimposed on the signal. After filtering out the double-line frequency ripple, which may be approximately 100 to approximately 120 Hz, the fictitious power can be fed to the primary controller. This is not different from the actual measured power, which will also have a ripple during unbalance. Thus, in some embodiments, no added complexity is introduced by the imaginary power compensation control method during unbalance.

In some embodiments, current limiting strategies may be used, such as the reference-saturation limiter and/or the virtual impedance limiter. Various limiter's control structures and influence on the inverter's fault behavior may differ in many ways, though it should not change the computation of fictitious power, as long as there's an E*and E. However, a well designed current limiter may benefit the imaginary power compensation control method and add to the large signal stability of the inverter. Although not detrimental to the synchronization method, careful consideration of the current limiter design and implementation is important.

In some embodiments, Zₓ is included as a design parameter that is fixed once chosen. However, in some embodiments, the imaginary power compensation control method may include the adaptability of Z_{y} in magnitude and angle during different conditions (i.e., the techniques provided herein may include changing the value of Z_{y} over time as a function of certain condition-dependent variables during operation). For example, in some embodiments, the magnitude of Z_{y} may be decreased during voltage dips to allow less dynamic angle swings during voltage dips.

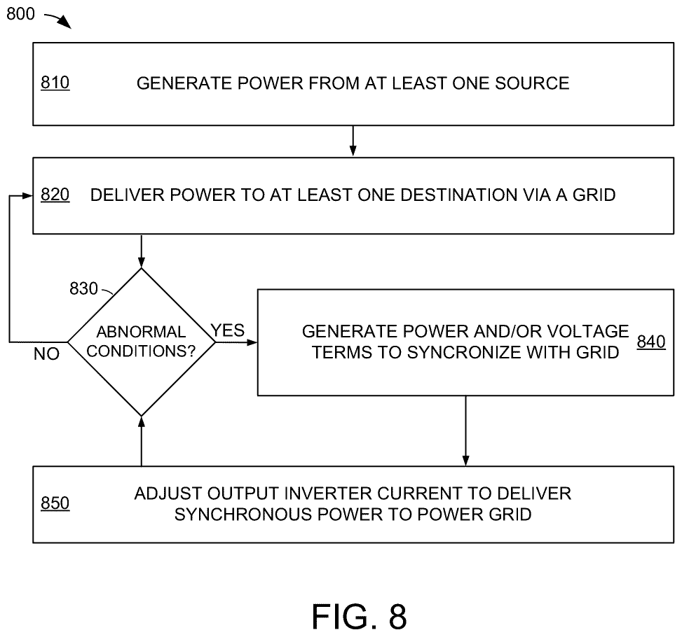

FIG. 8 illustrates an example power synchronization routine 800 that may be carried out by the assorted embodiments of an inverter shown in FIGS. 2-7. Initially, a power system converts DC power from at least one power source, such as a PV system, wind turbine, or hydroelectric generator, into AC power in step 810 that is transmitted to one or more destinations, such as residential, commercial, or industrial sites, in step 820 via aspects of a power grid. The operation of steps 810 and 820 may occur over time with nominal operating conditions. For instance, electric power may be provided to the power grid within a predetermined voltage and/or current range at a predetermined frequency.

Decision 830 evaluates one or more operating conditions of a power source, destination, or aspect of the grid, such as the output current of an inverter. In the event one or more abnormal conditions exist, such as a divergence from a reference frequency, step 840 calculates a compensatory output voltage and/or power by generating a non-zero power and/or voltage term. The use of the non-zero power term and/or voltage term to calculate output power and/or output voltage for an inverter allows for power to be delivered to the power grid in step 850 that is optimized for synchronization with the existing, abnormal grid operating conditions.

To clarify, in steps 810 and 820, which may be characterized as normal operating conditions, an inverter controller assigns a zero value to compensatory power and voltage terms until decision 830 identifies an abnormal operating condition, which results in step 840 to calculate non-zero compensatory power and/or voltage terms to ensure power is delivered in step 850 that easily synchronizes with the operating conditions of the power grid.

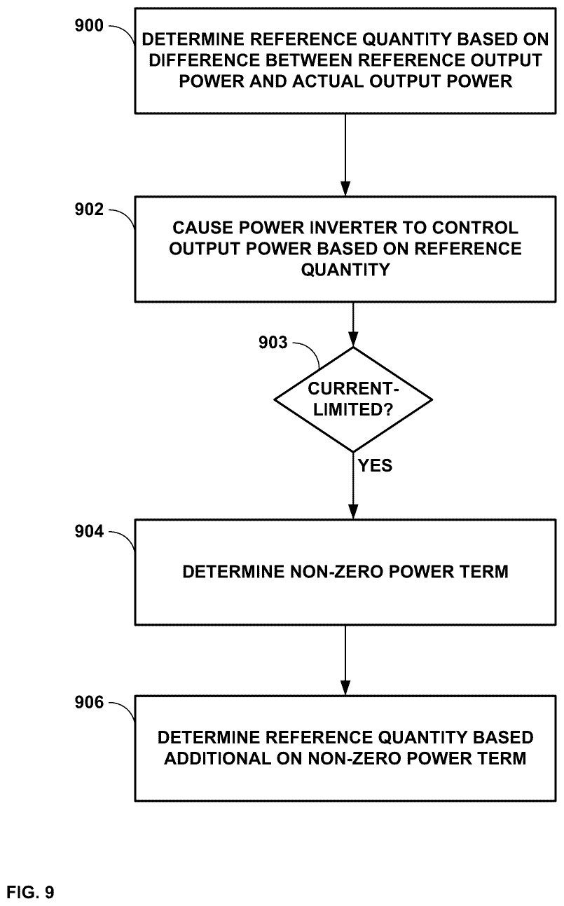

FIG. 9 illustrates a flowchart of imaginary power compensation control that may be carried out with the various embodiments of a power synchronization system. For illustration, the operations of FIG. 9 are described below within the context of FIG. 3. The operations shown in the example of FIG. 9 represent only one example of imaginary power compensation control as disclosed herein, and other examples may include different or additional operations.

In the example of FIG. 9, a device comprising at least one processor may be configured to determine a reference quantity based on a difference between a reference output power for a power inverter and an actual output power of the power inverter 900. For example, the primary controller 310 of grid forming inverter 300 may be configured to implement droop control and may determine a reference frequency based on a difference between a reference output real power and its actual output real power.

In the example of FIG. 9, the device may be configured to cause the power inverter to control its power output based on the reference quantity 902. For example, inverter 300 may output power based on the determined reference frequency.

In the example of FIG. 9, responsive to the power inverter entering current-limiting operation (“YES” branch of operation 903), the device may determine a non-zero power term that represents an additional amount of power that the inverter would have outputted if not current-limited 904. For example, inverter 300 may determine P_{fict} to be non-zero as detailed herein (e.g., using Eq. (5)).

In the example of FIG. 9, the device may determine the reference quantity based further on the non-zero power term 906. For example, inverter 300 may calculate the reference frequency using, e.g., Eq. (3).

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above.

The assorted methods, processes, and routines of the present disclosure are not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A device comprising:
at least one processor configured to:
determine a reference quantity based on a difference between a reference output power for a power inverter and an actual output power of the power inverter;
cause the power inverter to control its power output based on the reference quantity; and
responsive to the power inverter entering current-limiting operation:
determine a non-zero power term that represents an additional amount of power that the inverter would have outputted if not current-limited; and
determine the reference quantity based further on the non-zero power term.

2. The device of claim 1, wherein:
determining the reference quantity comprises determining a reference angle;
the reference output power and the actual output power each comprises a real power; and
determining the non-zero power term comprises determining a real power term.

3. The device of claim 2, wherein the at least one processor is further configured to:
determine a reference voltage based on a difference between a reference reactive output power for the power inverter and an actual reactive output power of the power inverter;
cause the power inverter to control its power output based additionally on the reference voltage; and
responsive to the power inverter entering current-limiting operation:
determine a non-zero reactive power term that represents an additional amount of reactive power that the inverter would have outputted if not current-limited; and
determine the reference voltage based further on the non-zero reactive power term.

4. The device of claim 1, wherein:
determining the reference quantity comprises determining a reference voltage;
the reference output power and the actual output power each comprises a reactive power; and
determining the non-zero power term comprises determining a reactive power term.

5. The device of claim 1, wherein determining the reference quantity and determining the non-zero power term are performed in a synchronous (dq) reference frame.

6. The device of claim 1, wherein determining the reference quantity and determining the non-zero power term are performed in a natural (abc) reference frame.

7. The device of claim 1, wherein determining the reference quantity and determining the non-zero power term are performed in a stationary (aß) reference frame.

8. The device of claim 1, wherein determining the reference quantity and determining the non-zero power term are performed in a decoupled double synchronous reference frame.

9. The device of claim 1, wherein the device is the power inverter.

10. A method comprising:
providing, by a power inverter comprising at least one processor, power to a power system to which the power inverter is connected;
assigning, by the power inverter, a zero value to a power term; and
responsive to detecting an abnormal operating condition, calculating, by the inverter, a non-zero value for the power term, the power term being used by the power inverter to synchronize, to the power system, the power output by the power inverter.

11. The method of claim 10, wherein the non-zero value for the power term accounts for a power that is not being injected into the power system due to current limiting of the power inverter.

12. The method of claim 10, wherein the power inverter is configured to implement droop control.

13. The method of claim 10, wherein the power inverter is configured to implement virtual synchronous machine control.

14. The method of claim 10, wherein the inverter is configured to implement virtual oscillator-based control.

15. The method of claim 10, wherein the non-zero value for the power term is calculated in a synchronous reference frame.

16. The method of claim 10, wherein the non-zero value for the power term is calculated in a decoupled double synchronous reference frame.

17. The method of claim 10, wherein the non-zero value for the power term is calculated in a natural reference frame.

18. The method of claim 1, wherein the abnormal condition is detected with a divergence in a reference frequency.

19. The method of claim 1, wherein the abnormal condition is detected with a reduction in output current for the inverter.

20. The method of claim 1, wherein
calculating the non-zero value for the power term comprises calculating
$$ℜ ( {\underline{E}}^{*} \overline{( \frac{{\underline{E}}^{⋆} - \underline{E}}{{\underline{Z}}_{X}} )} ) ;$$
E represents a complex output voltage of the power inverter;
E* represents a complex reference voltage; and
Zₓ represents an impedance.
